(19) United States
(12) Patent Application Publication
(10) Pub. No.: US 2009/0229536 A1
(43) Pub. Date: Sep. 17, 2009

(54) Pet stroller for bicycle attachment

(76) Inventor: Kevin Chen, Taichung City (TW)

Correspondence Address: DAVID LEWIS, 1250 AVIATION AVE., SUITE 200B, SAN JOSE, CA, 95110, US

(21) Appl. No.: 12/076,007

(22) Filed: Mar. 12, 2008

(51) Int. Cl. A01K 29/00; B62J 39/00

(52) U.S. Cl. 119/771; 280/288.4

(57) ABSTRACT

A pet stroller for bicycle attachment being attached to the seat post of a bicycle comprises a first rod member and a second rod member, wherein first rod member is attached to seat post at one end thereof and is extended to the rear of seat post of the bicycle at another end thereof, further, the intersection angle between first rod member and the longitudinal axis of seat post appears 90°, while second rod member being attached to one end of first rod member far away from seat post is sidewisw extended away from bicycle, and is further made with a leash-tying portion, wherein at least one rod member is partially made of elastic material.

### BACKGROUND OF THE INVENTION

(a) Field of the Invention

The invention is related to pet apparatus, particularly to a pet stroller for bicycle attachment.

(b) Description of the Prior Art:

The conventional bicycle use dog jogger as shown in FIG. 8 is constituted by a slightly elastic branch rod 1 made of polyurethane material, wherein the branch rod 1 is attached to the vicinity of axel of rear wheel 3 of bicycle 2 at one end thereof and is tied with a leash at the rear end thereof to connect with a pet collar, so that when bicycle 2 is ridden to march forward, the pet is pulled by the leash tied at rear end of the branch rod 1 to move along. However, as the bicycle use dog jogger is attached to the vicinity of axel of rear wheel 3 of bicycle 2, when the pet is not moving along with the marching direction of bicycle 2, the rear wheel 3 of bicycle 2 may be swung to seriously affect the safety of bicycle 2 in marching movement. Further, branch rod 1 made of polyurethane is not strong enough to pull large dogs, and usually appears a fragmentation phenomenon after time of use, therefore it is disadvantageous to be easily damaged.

Another kind of conventional bicycle use dog jogger as shown in FIG. 9 having one metal branch rod 1A is attached on seat post 3A of bicycle 2A at one end thereof and is tied with the leash at the other end thereof, wherein as this kind of bicycle dog jogger design is attached on the seat post 3A, when pet is not moving along with the marching direction of bicycle, the self-weight of rider on top of the seat post 3A makes the bicycle 2A march more stably, uneasily pulled by the pet. However, since the metal branch rod 1A is attached on seat post 3A to extend sidewise from bicycle 2A, when rider is stepping on the paddles of bicycle 2A, the thigh of rider tend to collide with the metal branch rod 1A that causes inconvenience of rider in riding bicycle 2A.

Additional another bicycle use dog jogger as shown in FIG. 10 is similarly attached on seat post 3B of bicycle 2B to be extended sidewise from bicycle 2B and further extended downward to appear a “U” shaped rod 4B, and rear end of the “U” shaped rod 4B is constituted by a spring, whereby the pet leash is tied to said spring to allow the spring to buffer the lateral force imposed by the pet. Nonetheless, this kind of bicycle use dog jogger has a bigger volume and a higher cost due to that its “U” shaped rod 4B is made of metal material, and further, for this kind of bicycle dog jogger, the thighs of rider may still collide with the rod sidewise extended away from bicycle 2B when rider steps on the paddles of bicycle 2B, that also causes inconvenience of rider in riding bicycle 2B.

### SUMMARY OF THE INVENTION

The main purpose of the invention is to disclose a pet stroller for bicycle attachment which has a simple structure with characteristics of excellent strength and durable usage.

The second purpose of the invention is to disclose a pet stroller for bicycle attachment which can eliminate the lateral pulling force imposed by the pets moving in a direction different from the marching direction of the bicycle,in addition,when pet has a sudden rush, this apparatus can effective offer a buffer for rider.

To achieve aforesaid purposes, the invention discloses a pet stroller for bicycle attachment which is installed on the seat post of bicycle and comprises a first rod member and a second rod member, wherein first rod member is attached to the seat post at one end thereof and is extended to rear of seat post of the bicycle at another end thereof, further, intersection angle between first rod member and the longitudinal axis of seat post appears 90°, while second rod member being attached to one end of first rod member far away from seat post is sidewise extended away from bicycle, and is further made with a leash-tying portion, wherein at least one rod member is partially made of elastic material.

### BRIEF DESCRIPTION OF THE DRAWINGS

FIG. 1 is a perspective schematic view of the invention.

FIG. 2 is a schematic view of the invention in usage status showing that the invention is mounted on seat post of the bicycle.

FIG. 2B is a frontal schematic view showing the invention is mounted on the seat post.

FIG. 3 is a schematic view showing the status of the invention being imposed by a lateral force.

FIG. 4 is a perspective view of the locking elements of the invention.

FIG. 5 is a side cross-sectional view of the invention showing that locking elements are installed on the spring.

FIG. 6 is a perspective schematic view of the second preferred embodiment of the invention.

FIG. 7 is a perspective schematic view of the third preferred embodiment of the invention.

FIG. 8 is a schematic view of conventional bicycle dog jogger.

FIG. 9 is a schematic view of another conventional bicycle dog jogger.

FIG. 10 is a schematic view of additional another conventional bicycle dog jogger.

### DETAIL DESCRIPTION OF THE PREFERRED EMBODIMENTS

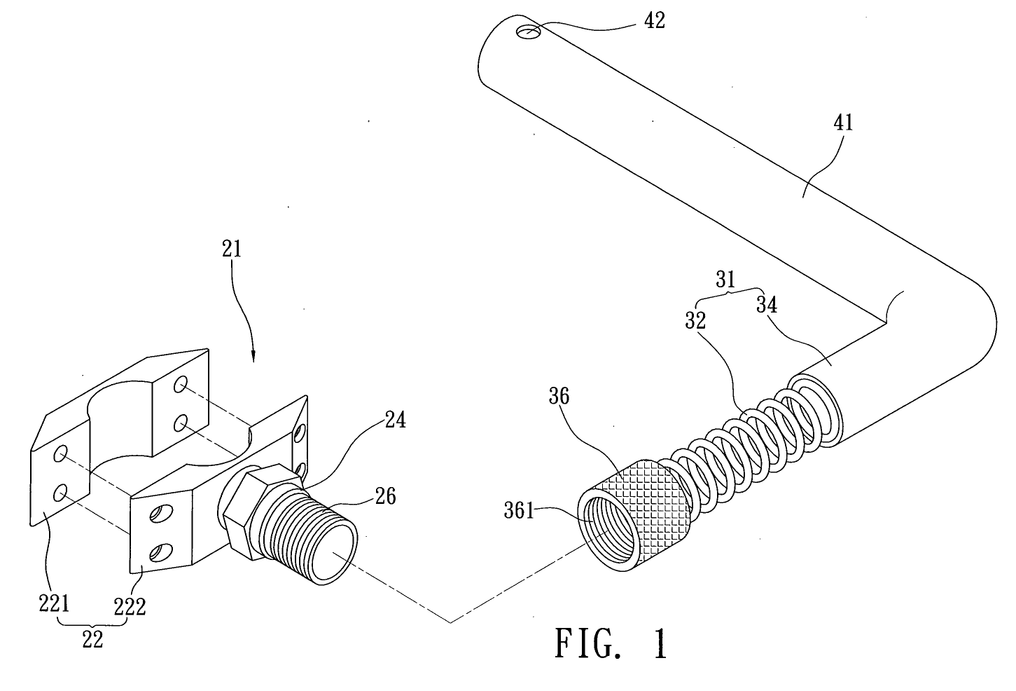

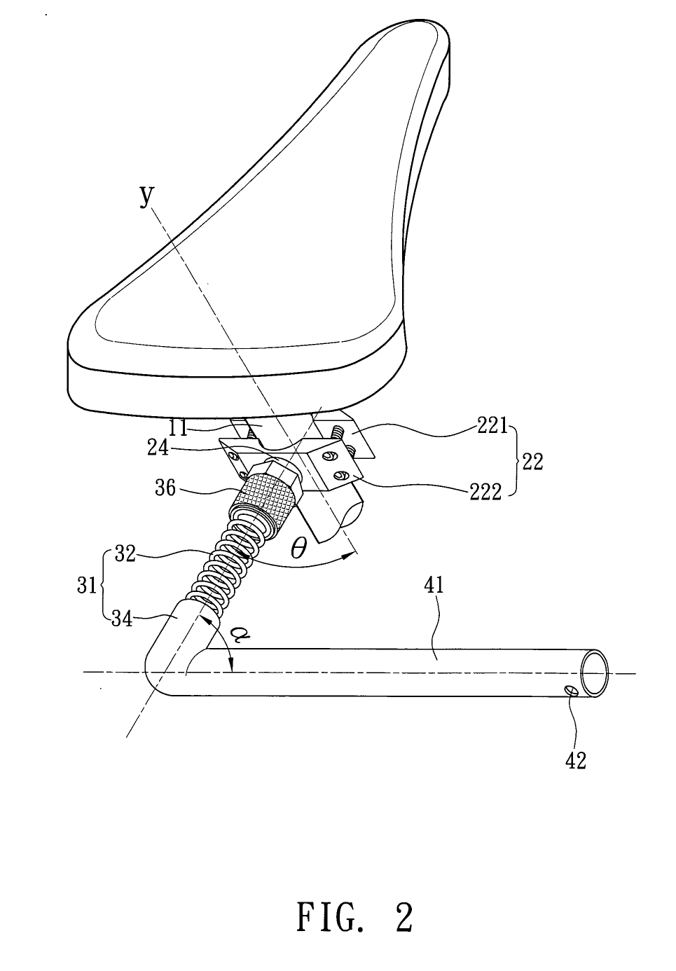

A pet stroller for bicycle attachment disclosed by the invention as shown in FIGS. 1 and 2 is installed on the seat post 11 of bicycle (not shown in the Fig.) and mainly comprises a connector component 21, a first rod member 31 and a second rod member 41, wherein:

The connector component 21 has a join part 22 comprising two relative clamping pieces 221, 222 at one end thereof and is further extended to have a connector pipe 24 at the rear end thereof to affix on seat post 11 of the bicycle through clamping by the join part 22. As shown in FIG. 2B, when connector component 21 is affixed on the seat post 11, whether the seat post 11 an inclined angle or not, the intersection angle θ between connector pipe 24 of connector component 21 and the longitudinal axis y of seat post 11 appears 90°, further, the connector pipe 24 is made with a fixing portion 26 having an external threaded section in the embodiment;

First rod member 31 comprises a spring 32 and a metal rod 34, wherein one end of spring 32 is made with a lock-connect portion 36 which is made with an internal threaded portion 361 for matching with external threaded portion of fixing portion 26 in the embodiment, wherein internal threaded section 361 of lock-connect portion 36 of first rod member 31 is mutually lockingly connected with external threaded section of fixing portion 26 of connector pipe 24 to allow first rod member 31 to affix to connector pipe 24 of connector component 21, and metal rod 34 of first rod member 31 is extended toward the rear of seat post 11 of the bicycle, further, since first rod member 31 is relying on lock-connect portion 36 to attach with connector pipe 24, the intersection angle θ between first rod member 31 and saddle longitudinal axis y also appears 90°;

Second rod member 41 is made of metal material, wherein second rod member 41 with its top end thereof being affixed to the rear end of metal rod 34 of first rod member 31 far away from seat post 11 is extended sidewise from bicycle (intersection angle between second rod member 41 and first rod member 31 appears 90°) and is made with a through hole type leash-tying portion 42 at the rear end thereof for tying a pull leash.

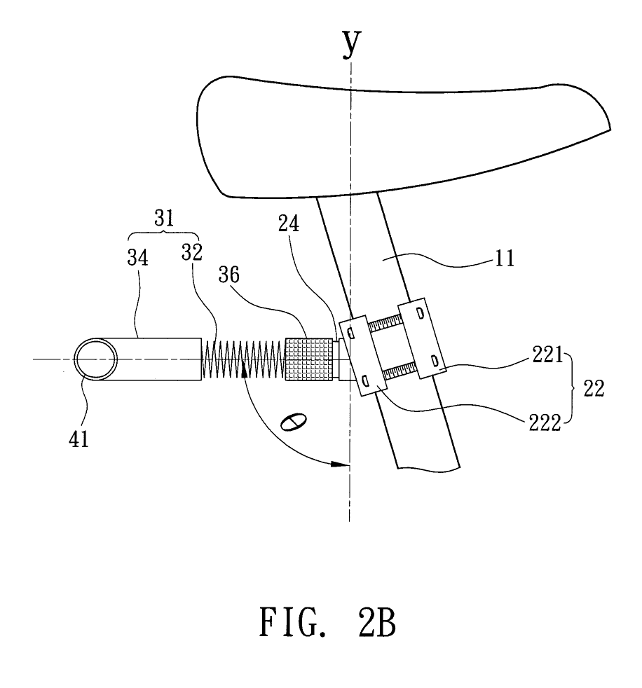

For practical application of said described structure of the invention as shown in FIG. 3, when pet imposes a lateral pulling force on the bicycle, the pet stroller for bicycle attachment is bended at spring 32 whereby to buffer the lateral force in order to reduce direct impact of lateral force on seat post 11. Additionally, as first rod member 31 of the pet stroller for bicycle attachment is first extended a predetermined distance to the rear of seat post 11 of the bicycle, and second rod member 41 is further sidely extended away from bicycle, the thigh of the rider in riding bicycle won't collided by the pet stroller for bicycle attachment thereby allowing rider to step on the bicycle paddles smoothly.

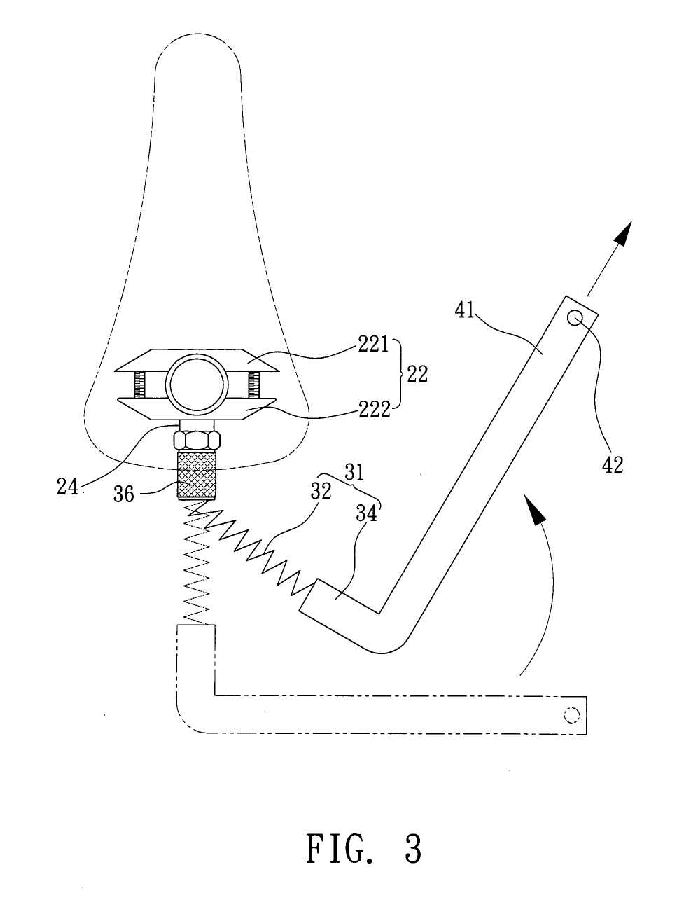

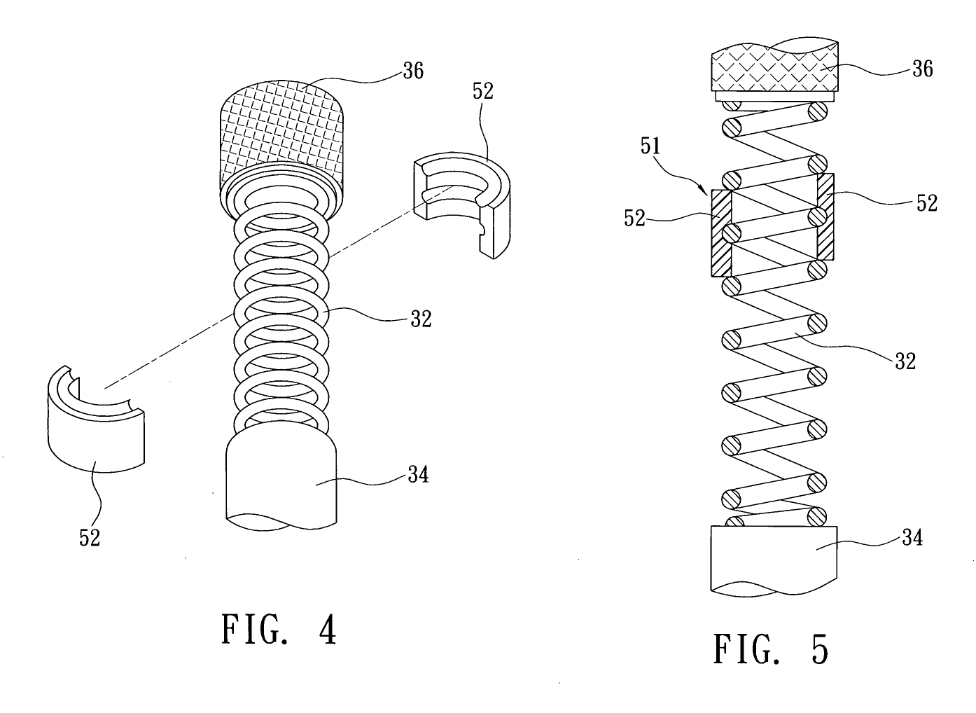

Subsequently, as referring to FIGS. 4 and 5, spring 32 of first rod member 31 is further installed with a locking element 51 comprising two relative pieces like structures 52 for ring installation in the clearance 321 of spring 32 to limit deformation of spring 32 when it is forced to deform, wherein number of locking elements 51 installed on spring 32 can be changed to randomly adjust the coefficient of elasticity provided by spring 32 corresponding to different requirements.

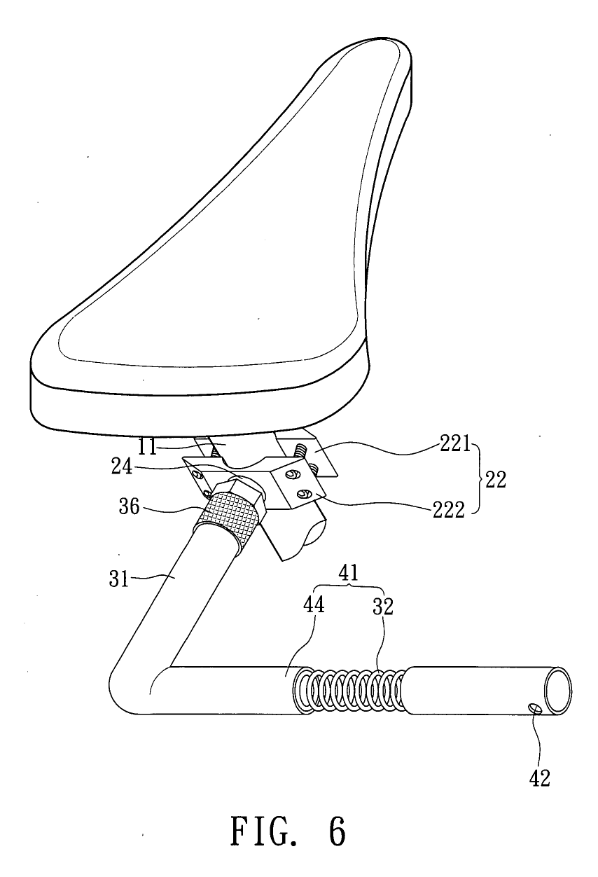

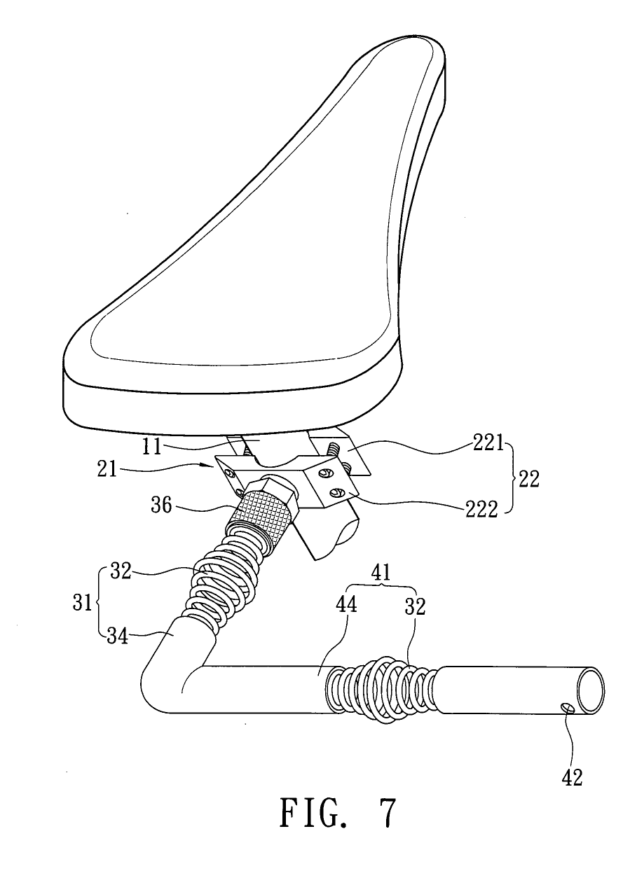

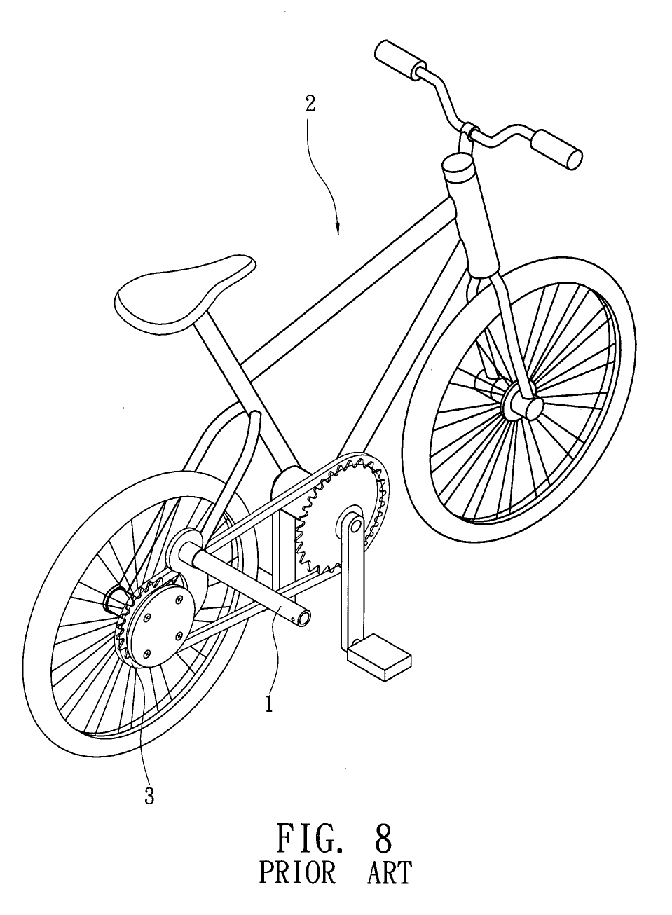

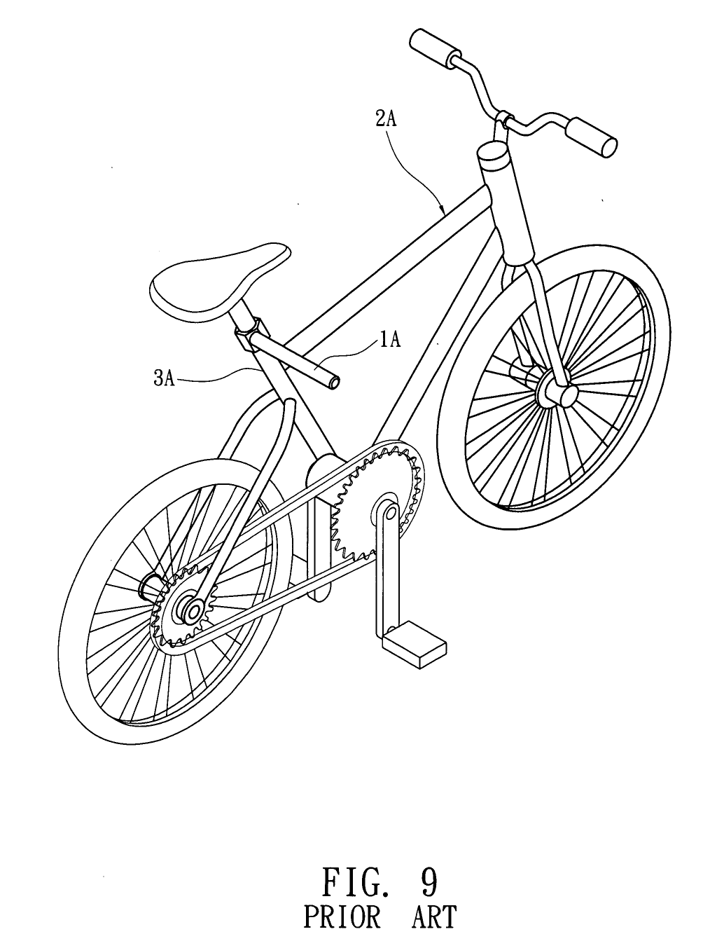

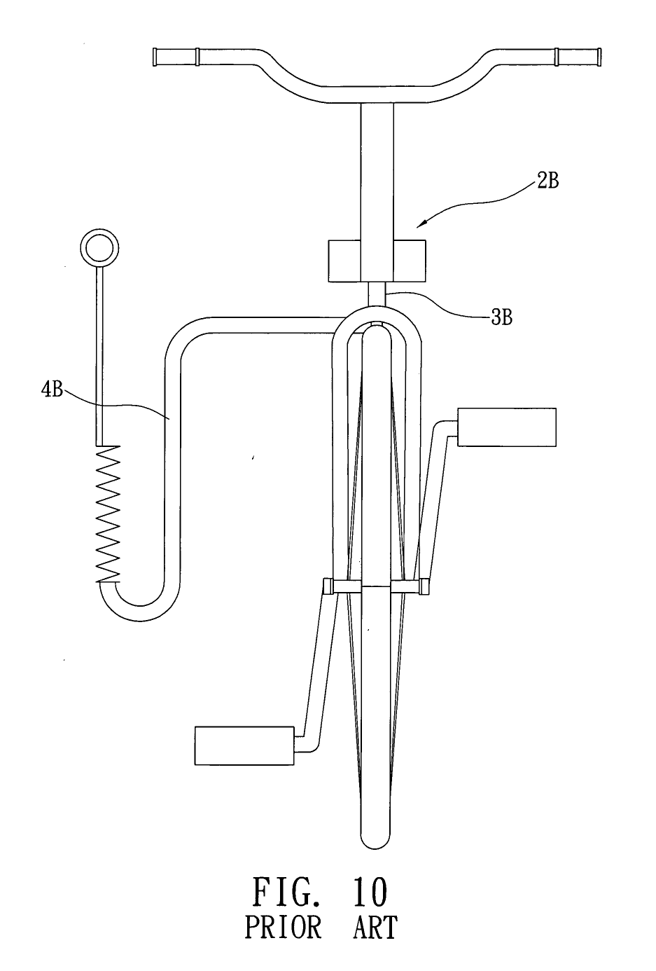

FIG. 6 is the second preferred embodiment of the invention, wherein first rod member 31 is constituted by a metal rod while second rod member 41 is constituted by connecting a spring 32 and a metal rod 44, whereby through the function of spring 32 of second rod member 41, the pet imposed lateral force can be similarly buffered. FIG. 7 is the third preferred embodiment of the invention, wherein first rod member 31 and second rod member 41 are respectively constituted by connecting a spring 32 and a metal rod 34, 44. Nonetheless, it is particularly mentioned herein, installing location of spring 32 is not limited to the disclosed types of above said embodiments, all of the arrangements to allow the impact on seat post 11 of the bicycle caused by pet imposed lateral force acting on first rod member 31 and second rod member 41 of the invention to be buffered through the effect of spring 32 shall be considered as the equivalent embodiments of the invention.

I claim:

1. A pet stroller for bicycle attachment being attached to the seat post of a bicycle comprises a first rod member and a second rod member, wherein first rod member is attached to seat post at one end thereof and is extended to the rear of seat post of the bicycle at another end thereof, further, intersection angle between first rod member and the longitudinal axis of seat post appears 90°, while second rod member being attached to one end of first rod member far away from seat post is sidewise extended away from bicycle, and is further made with a leash-tying portion, wherein at least one rod member is partially made of elastic material.

2. The pet stroller for bicycle attachment as claimed in claim 1, wherein the leash-tying portion is a through hole for fixedly tying by a pull leash.

3. The pet stroller for bicycle attachment as claimed in claim 1, wherein first rod member is constituted by connecting a spring and a metal rod.

4. The pet stroller for bicycle attachment as claimed in claim 1, wherein second rod member is constituted by connecting a spring and a metal rod.

5. The pet stroller for bicycle attachment as claimed in claim 1, wherein first rod member and second rod member are respectively constituted by connecting a spring and a metal rod.

6. The pet stroller for bicycle attachment as claimed in claim 1, wherein it is further provided a connector component which has a join part at one end thereof and is further extended to have a connector pipe at the rear end thereof to affix on seat post of the bicycle through clamping by the join part, and the intersection angle between connector pipe of connector component and the longitudinal axis of seat post appears 900, further, the connector pipe is made with a fixing portion having an external threaded section in the embodiment, in addition, the first rod member is made with a lock-connect portion which is made with an internal threaded section to match with the external threaded section of the fixing portion, wherein internal threaded section of lock-connect portion of first rod member is mutually and lockingly connected with the external threaded section of the fixing portion of connector pipe.

7. The pet stroller for bicycle attachment as claimed in claim 6, wherein join part of connector component comprises two relative clamping pieces for clampingly affixing to seat post of the bicycle.

8. The pet stroller for bicycle attachment as claimed in claim 1, wherein at least one rod member partially comprises a spring.

9. The pet stroller for bicycle attachment as claimed in claim 8, wherein spring of first rod member is installed with a locking element comprising two relative pieces like structures for ring installation in the clearance of spring.
